(19) United States
(12) Patent Application Publication
(10) Pub. No.: US 2005/0078662 A1
(43) Pub. Date: Apr. 14, 2005

(54) Signal integration system

(76) Inventors: Jung-Jen Weng, Kaohsiung (TW); Rong-Tarng Yu, Kaohsiung (TW); Yuan-Shiang Chang, Taipei (TW); Ju-Hang Kuo, Taipei (TW)

Correspondence Address: BIRCH STEWART KOLASCH & BIRCH, PO BOX 747, FALLS CHURCH, VA, 22040-0747, US

(21) Appl. No.: 10/961,051

(22) Filed: Oct. 12, 2004

(30) Foreign Application Priority Data
Oct. 14, 2003 (TW) 92128398

(51) Int. Cl. H04L 12/66

(52) U.S. Cl. 370/352

(57) ABSTRACT

A signal integration system for integrating signals of public switched telephone network (PSTN) and Internet protocol (IP) is provided. The system includes a wireless local area network and a signal switch device. PSTN signals can be converted to IP signals via the signal switch device and IP signals can be also converted to PSTN signals via the signal switch device.

This Application claims priority to Taiwan Patent Application No. 092128398 filed on Oct. 14, 2003.

### FIELD OF INVENTION

The present invention relates to an integration system for integrating signals of public switched telephone network and Internet protocol.

### BACKGROUND OF THE INVENTION

With the evolution of computer and network technology, digital data, such as email and message, now can be transmitted promptly and efficiently through an exclusive network environment.

Internet protocol has become a prevalent Internet transmission standard since 90s. In addition to World Wide Web (WWW), there are more and more communication applications using Internet protocol. One of them is to transmit audio data through the Internet in the format of Internet protocol after the audio data is digitalized. The quality of such transmission is, however, not splendid enough at the outset due to narrow bandwidth. Since the issue of Internet bandwidth is improved in the past few years, voice over IP (VoIP) turns to be a mature and popular service. It is then an idea coming to customers' mind to integrate the conventional phone network and IP.

In view of the requirement above, there are already some solutions in the current market. For example, Cisco IP Phone 7900 series can connect to Ethernet to transmit voice, and IP Phone 7920 series further uses the wireless communication standard, IEEE 802.11b, to transmit audio data through a wireless local network phone system.

The IP private branch exchange (PBX) of the aforementioned Cisco integration system is regarded as a core device of the whole system, which is simply adapted for data exchanging between conventional phones and IP phones. The other data transmissions, such as WWW, FTP and file sharing, still need a hub, a switch or a router to proceed.

Therefore, there is a need to integrate IP PBXs and hubs, switches and routers together. It is even more convenient if the function of wireless communication can be integrated as well.

### SUMMARY OF THE INVENTION

The present invention provides a signal integration system for integrating signals of a public switched telephone network and signals of an Internet protocol of an Internet. The system includes a first wireless local area network and a first signal switch device. The first signal switch device is connected to, or is located within, the first wireless local area network and includes a first interface and a second interface. The first interface, connected to the public switched telephone network, is configured to input and output signals of the public switched telephone network. The second interface, connected to the Internet, is configured to input and output signals of the Internet protocol.

The first signal switch device converts a first signal of the public switched telephone network into a first signal of the Internet protocol, and the first signal of the Internet protocol is then transmitted to either the first wireless local area network or the Internet through the second interface. The first signal switch device also proceeds with a second signal of the Internet protocol coming from the second interface and transmits it to the first wireless local area network, or converts into a second signal of the public switched telephone network which is transmitted to the public switched telephone network through the first interface thereafter.

The signal integration system of the present invention further includes a second signal switch device which is connected to the second interface of the first signal switch device via the Internet. The first and the second signals of the Internet protocol can be outputted to the second signal switch device through the second interface of the first signal switch device and the Internet.

The signal integration system further includes a second wireless local area network which is connected to the second signal switch device. The first and the second signals of the Internet protocol can be transmitted to the second wireless local area network through the second signal switch device.

### BRIEF DESCRIPTION OF THE DRAWINGS

FIG. 1 illustrates the first embodiment of the present invention;

FIG. 2 illustrates the signal switch device of the present invention; and

FIG. 3 illustrates the second embodiment of the present invention.

### DETAILED DESCRIPTION

The present invention provides a signal integration system for integrating signals of a public switched telephone network and signals of an Internet protocol of an Internet so that the signals of the two different transmission protocols can be coordinated.

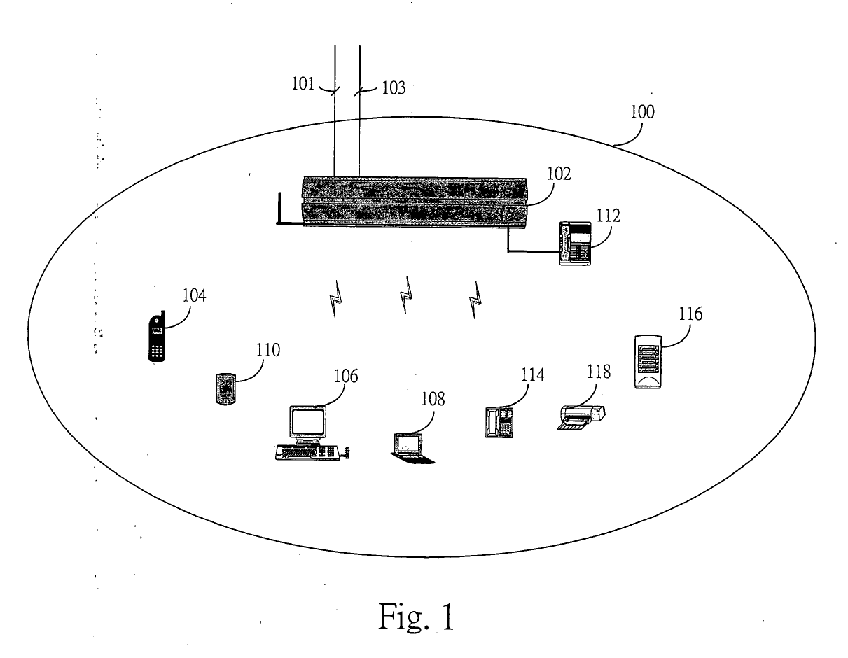

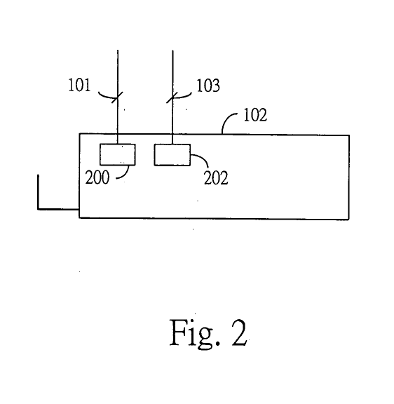

As FIG. 1 shows, a first embodiment of the present invention includes a first wireless local area network 100 and a first signal switch device 102. The first signal switch device 102, connected to the first wireless local area network 100, includes a first interface and a second interface. Referring to FIG. 2 now, the first interface 200, which is connected to the public switched telephone network, is configured as an I/O interface to input and output signals 101 of the public switched telephone network. The second interface 202, which is connected to the Internet, is configured as an I/O interface to input and output signals 103 of the Internet protocol.

The second interface 202 accepts the signals 103 of the Internet protocol in the formats of TCP/IP, SIP (IETF RFC-3261), RTP (ETF RFC-1889), RTCP (IETF RFC-1890) and SDP (IETF RFC-2327).

A first signal within the signals 101 is inputted to the first signal switch device 102 through a public phone line. The signal switch device 102 is capable of converting the first signal of the public switched telephone network into a first signal of the Internet protocol. The first signal of the Internet protocol, responsive to a registration information of a user (not shown), is then transmitted to one of the communication devices 104, 106, . . . , 118 used by the user through the first wireless local area network 100. Similarly, a second signal within the signals 103 is inputted to the first signal switch device 102 through an Ethernet line. The first signal switch device 102, responsive to the information registered by the user, transmits the second signal of the Internet protocol to one of the communication devices 104, 106, . . . , 118 used by the user through the first wireless local area network 100, or alternatively converts the second signal of the Internet protocol into a second signal of the public switched telephone network which is thereafter transmitted to the public switched telephone network through the first interface 200 and the public phone line.

An application example is that, as FIG. 1 shows, if the user registers onto the first signal switch device 102 by a wireless phone 104, the first signal switch device 102, responsive to the information of registration, automatically forwards an email to the wireless phone 104 through the first wireless local area network 100 when the email is received from the second interface 202. Therefore, the user may be aware of the coming email promptly.

Another application example is that the user may use a computer 106 to dial a phone number. The corresponding signal, being converted into a signal of the public switched telephone network by the first signal switch device 102, is outputted from the first interface 200 through the first wireless local area network 100. The user also may dial a phone number by the wireless phone 104. The corresponding signal, being converted into a signal of Internet protocol by the first signal switch device 102, is outputted from the second interface 202 through the first wireless local area network 100.

According to the detailed description above, the signal integration system is capable of integrating the signals 101 and the signals 103 in the range of the first wireless local area network 100. In addition to the wireless phone 104 and the computer 106, the communication devices within the first wireless local area network 100 further may include, but not limit to, laptop computer 108, personal digital assistant (PDA) 110, an analog phone 112, an IP phone 114, a server 116, a remote printer 118, and so on. All of these communication devices can communicate with one another through the first wireless local area network 100 and the first signal switch device 102.

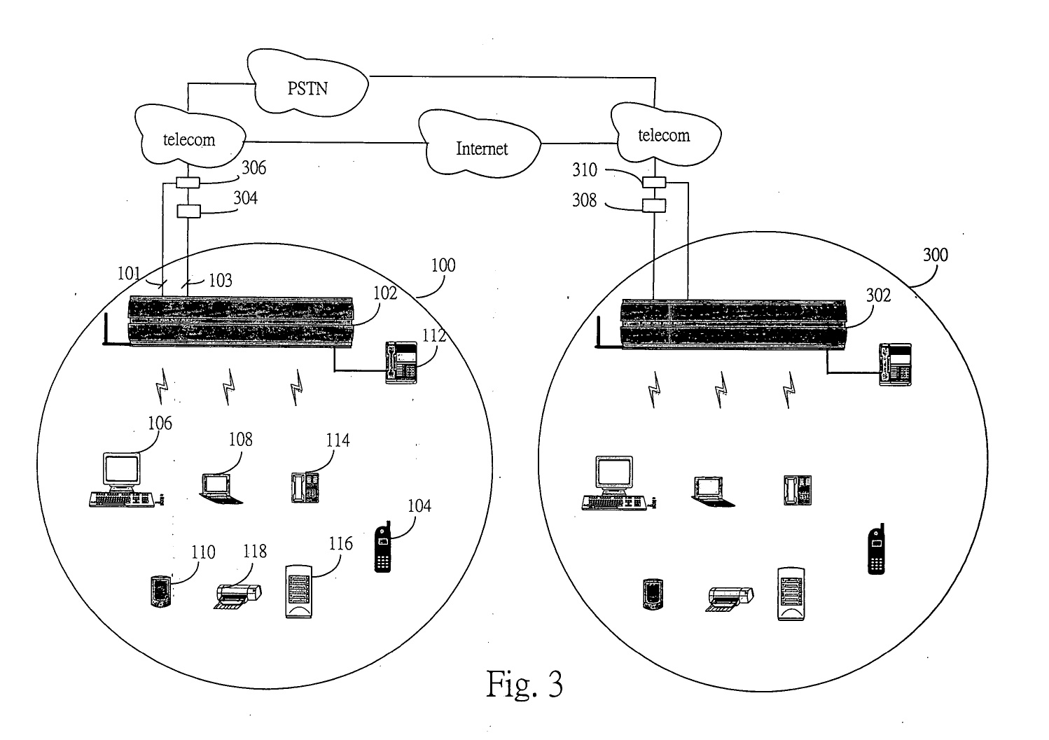

A second embodiment of the present invention is shown in FIG. 3. In addition to the communication devices of the above first embodiment, the signal integration system of the second embodiment further includes a second signal switch device 302. The second signal switch device 302 is connected to the second interface 202 of the first signal switch device 102 via the Internet and telecommunication companies. The aforementioned first and the second signals of the Internet protocol can be outputted to the second signal switch device 302 through the second interface 202 of the first signal switch device 102, a modem 304, and a frequency separator 306 under the command of the first signal switch device 102.

When receiving the signals 101 of the public switched telephone network, the first signal switch device 102 also can transmit the signals 101 to the second signal switch device 302 through the first interface 200 of the first signal switch device 102 and the frequency separator 306 if the user registers onto the second signal switch device 302.

The signal integration system of the second embodiment further includes a second wireless local area network 300 which is connected to the second signal switch device 302. The first wireless local area network 100 and the second wireless local area network 300 are remote from each other. All of the signals coming from the first interface 200 and the second interface 202 of the first signal switch device 102 can be received by the second signal switch device 302 through a frequency separator 310 and a modem 308. The second signal switch device 302 converts the signals from the first signal switch device 102 into either signals of Internet protocol or the public switched telephone network and respectively transmits them to the second wireless local area network 300 and the public switched telephone network as appropriate.

The operations of the communication devices in the second wireless local area network 300 are the same as those in the first wireless local area network 100.

An application example for the second embodiment is that if the user locates and registers in the second wireless local area network 300, the signal integration system, responsive to the information of registration, transmits a phone call, inputting to the first signal switch device 102, toward the second signal switch device 302. The second signal switch device 302 then transmits the phone call to the user through the second wireless local area network 300.

To facilitate the communication among different groups of a company, one signal switch device of the present invention can be installed in each group. A user is able to receive email or phone calls as long as the user stays within any one of the wireless local area networks. Furthermore, a code may be assigned, to represent the user and includes some business information, such as the extension number and the email address of the user. The signal integration system, responsive to the code, transmits signals, e.g. a phone call, email, a message or the like, to the wireless local area network in which the code is registered. The actual location of the user is therefore not important any more when the concept of information exchange of the present invention is the concern. Besides, one can choose the most convenient and efficient way to communicate with the user. For example, if the user is in one of the branch offices, one can dial a local phone number to the local branch office. The signal switch device of the local branch automatically searches the location of the user and transmits the call to the wireless local area network of the branch office through the Internet. The user then answers the call.

The above description of the preferred embodiments is expected to clearly expound the characteristics of the present invention but not expected to restrict the scope of the present invention. Those skilled in the art will readily observe that numerous modifications and alterations of the system may be made while retaining the teaching of the invention. Accordingly, the above disclosure should be construed as limited only by the bounds of the claims.

1. A signal integration system for integrating signals of a public switched telephone network and signals of an Internet protocol of an Internet, comprising:
a first wireless local area network; and
a first signal switch device, connected to the first wireless local area network comprising:
a first interface, connected to the public switched telephone network, for inputting and outputting signals of the public switched telephone network; and
a second interface, connected to the Internet, for inputting and outputting signals of the Internet protocol;
wherein, the first signal switch device converts a first signal of the public switched telephone network into a first signal of the Internet protocol, and the first signal of the Internet protocol is transmitted to the first wireless local area network;
wherein, the first signal switch device converts a second signal of the Internet protocol into a second signal of the public switched telephone network, and the second signal of the public switched telephone network is transmitted to the public switched telephone network through the first interface.

2. The signal integration system of claim 1, wherein the first signal of the Internet protocol is outputted to the Internet through the second interface.

3. The signal integration system of claim 1, further comprising a second signal switch device connected to the second interface via the Internet, the first and the second signals of the Internet protocol being outputted to the second signal switch device through the second interface.

4. The signal integration system of claim 3, further comprising a second wireless local area network connected to the second signal switch device, the first and the second signals of the Internet protocol being transmitted to the second wireless local area network through the second signal switch device.

5. A signal integration system for integrating signals of a public switched telephone network and signals of an Internet protocol of an Internet, comprising:
a first wireless local area network;
a first signal switch device, connected to the first wireless local area network, comprising:
a first interface, connected to the public switched telephone network, for inputting and outputting signals of the public switched telephone network; and
a second interface, connected to the Internet, for inputting and outputting signals of the Internet protocol; and
a second signal switch device connected to the second interface via the Internet;
wherein, the first signal switch device converts a first signal of the public switched telephone network into a first signal of the Internet protocol, and the first signal of the Internet protocol is outputted to the second signal switch device through the second interface;
wherein, the first signal switch device. converts a second signal of the Internet protocol into a second signal of the public switched telephone network, and the second signal of the public switched telephone network is transmitted to the public switched telephone network through the first interface.

6. The signal integration system of claim 5, further comprising a second wireless local area network connected to the second signal switch device, the first and the second signals of the Internet protocol being transmitted to the second wireless local area network through the second signal switch device.
